(19) United States
(12) Patent Application Publication
(10) Pub. No.: US 2009/0155436 A1
(43) Pub. Date: Jun. 18, 2009

(54) Fluid container with a disposable filter

(76) Inventors: Douglas W. Chalmers, Palo Alto, CA (US); Matthew Zuckerman, New York, NY (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/002,084

(22) Filed: Dec. 13, 2007

(51) Int. Cl. B67D 1/07; A47G 19/22; B65B 25/00; B01D 24/36

(52) U.S. Cl. 426/398; 220/703; 210/474; 222/189.07

(57) ABSTRACT

Embodiments of a fluid container with a disposable filter have been presented. In some embodiments, the filter includes a housing having a top and a bottom, a first integral strainer coupled to the top, a second integral strainer coupled to the bottom, and some filtration particles stored within the housing between the first and the second integral strainers. Furthermore, some embodiments of the filter further include a flange coupled to the top, where the flange may have an outer circumference larger than a circumference of the top of the housing, and an inner circumference smaller than the circumference of the top of the housing.

### TECHNICAL FIELD

The present invention relates to fluid containers, and more particularly, to fluid containers with disposable filters.

### BACKGROUND

Conventionally, beverages, such as water, alcoholic beverages, etc., are filtered before bottling. Nevertheless, there may still be impurities left over in the beverages. Moreover, during the long shelf-life of some beverages, additional impurities or precipitation may form in the beverages or flavors of the beverages may change, which may adversely impact the taste of the beverages.

Beverage manufacturers essentially lose control of the bottled beverages once the bottled beverages are shipped to stores. They cannot process or control the handling of the bottled beverages after shipping.

### SUMMARY

Embodiments of a fluid container with a disposable filter are presented. In some embodiments, the filter includes a housing having a top and a bottom, a first integral strainer coupled to the top, a second integral strainer coupled to the bottom, and some filtration particles stored within the housing between the first and the second integral strainers. Furthermore, some embodiments of the filter further include a flange coupled to the top, where the flange may have an outer circumference larger than a circumference of the top of the housing, and an inner circumference smaller than the circumference of the top of the housing.

Other features of some embodiments of the present invention will be apparent from the accompanying drawings and from the detailed description that follows.

### BRIEF DESCRIPTION OF THE DRAWINGS

The present invention will be understood more fully from the detailed description that follows and from the accompanying drawings, which however, should not be taken to limit the appended claims to the specific embodiments shown, but are for explanation and understanding only.

FIG. 1A illustrates a cross-sectional view of one embodiment of a fluid container assembly.

FIG. 1B illustrates a top view of one embodiment of a fluid container assembly without a cap.

FIG. 2 illustrates a cross-sectional view of an alternate embodiment of a fluid container assembly.

FIG. 3 illustrates an alternate embodiment of a fluid container assembly.

FIG. 4 illustrates an alternative embodiment of a liquor filter usable with a liquor container.

FIG. 5 illustrates one embodiment of a process to bottle fluid.

### DETAILED DESCRIPTION

Embodiments of a fluid container assembly having a disposable filter are described below. In the following description, numerous specific details are set forth. However, it is understood that embodiments of the invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment. The term “to couple” as used herein may include both to directly couple and to indirectly couple through one or more intervening components. As used herein, the terms “upper,” “upwards,” “lower,” “downward,” “top,” “bottom,” “left,” and “right” are intended to provide relative positions for purposes of description, not to designate an absolute frame of reference. Furthermore, the dimensions of components illustrated in the drawings are meant to be illustrative, not limiting. It should be appreciated that variations in the dimensions of the components and the relative proportions of the components with respect to each other are possible in different embodiments.

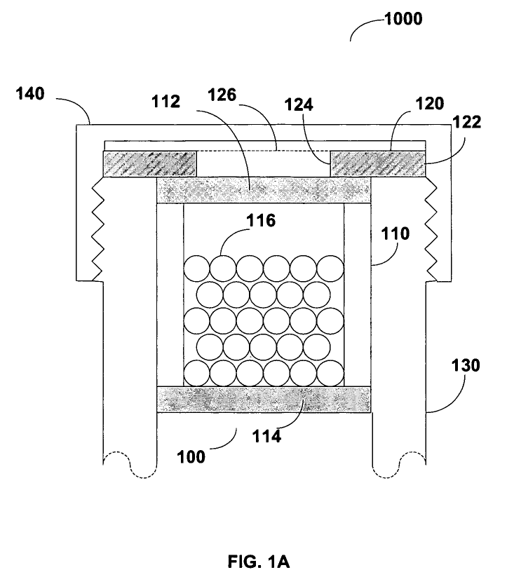

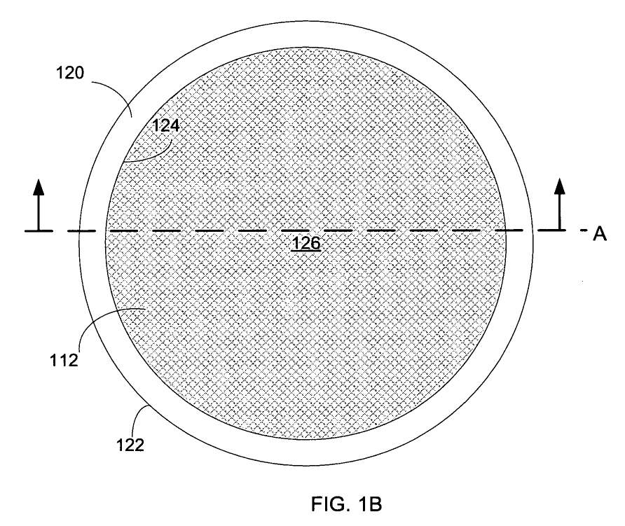

FIG. 1 shows a cross-sectional view of one embodiment of a fluid container assembly 1000. The fluid container assembly 1000 includes a filter 100 and a fluid container 130. The filter 100 may be inserted into an opening defined by a dispensing end of the fluid container 130 after the fluid container 130 has been substantially filled up with fluid. The fluid container 130 is a container for holding fluid, such as a bottle, a jar, etc. For instance, one example of the fluid container 130 is a vodka bottle. Furthermore, the fluid container 130 may be made of various materials, such as plastic, glass, etc. The fluid inside the fluid container 130 may be any type of fluid suitable for human consumption, such as alcoholic beverages (e.g., vodka, whiskey, wine, etc.), water, etc.

The filter 100 includes a housing 110, a first integral strainer 112 coupled to the top of the housing 110, a second integral strainer 114 coupled to the bottom of the housing 110, some filtration particles 116 stored inside the housing 110, and a flange 120 coupled to the first integral strainer 112.

In some embodiments, the housing 110 of the filter 100 may be made of various types of liquid-proof material that is safe to be in contact with food. Furthermore, the material may be flexible enough that the housing 110 may provide a substantially liquid-tight seal between the housing 110 and a portion of an inner surface of the fluid container 130 when inserted into the fluid container 130. Furthermore, to improve the appeal of the fluid container assembly 100 for marketing purpose, a clear or non-opaque material may be used to make the housing 110 in order to allow users of the fluid container assembly 1000 to view the filtration process (which is described in detail below). As such, a manufacturer of the fluid packaged in the fluid container assembly 1000 may show the users that the fluid is freshly filtered prior to being dispensed from the fluid container 130.

In some embodiments, the top and the bottom of the housing 110 are coupled to the integral strainers 112 and 114, respectively. For example, a sealant or an adhesive that is safe to be in contact with food may be applied to the edge of the integral strainers 112 and 114 in order to securely couple the integral strainers 112 and 114 to the top and the bottom of the housing 110, respectively. As such, users of the fluid container assembly 1000 may not replace the filtration particles 116 because the users would have to break the seal between the housing 110 and the integral strainers 112 and 114. The integral strainers 112 and 114 may be made of a mesh having small holes to allow the fluid to flow through easily while preventing the filtration particles 116 to fall out. In some embodiments, the holes of the mesh are of a size of approximately 2.8 mm in diameter. Note that the integral strainers 112 and 114 may or may not be made of the same material and may or may not have holes of the same size.

In one embodiment, for a standard 0.75 Liter bottle, the interior diameter of the fluid container 130 is about 19.05 mm. The exterior diameter of the filter 100 is about 19.05 mm. The length of the filter 100 is about 50.8 mm. The thickness of the wall of the housing 110 is about 1.8 mm. The exterior diameter of the flange 120 is about 22.9 mm and the thickness of the flange 120 is about 1 mm. Note that the above dimensions are provided as an example to illustrate the concept. It should be appreciated that other embodiments may have different dimensions.

The housing 110 of the filter 100 defines a cavity for storing the filtration particles 116. As mentioned above, the filtration particles 116 are prevented from falling out of the housing 110 by the integral strainers 112 and 114. In some embodiments, the filtration particles are of a size of approximately 3.35 mm in diameter, and approximately 4.75 mm in length. The above dimension corresponds to an industry standard size of “4×6 mesh.” In some embodiments, the housing 110 may be filled ¾ full of the filtration particles 116.

Furthermore, the filtration particles 116 are generally safe for processing fluid for human consumption. For example, the filtration particles 116 may include activated carbon pellets having a formulation that is recognized as “Generally Recognized as Safe” (GRAS) by the Food and Drug Agency (FDA). Furthermore, the activated carbon pellets are used in accordance with Good Manufacturing Practice (GMP) and contain no residues of heavy metals or other contaminants in excess of FDA tolerances. In addition, the activated carbon pellets may follow the Food Chemicals Codex (1996) specifications for food grade activated carbon. For instance, the filtration particles 116 may be made of food grade carbonaceous material, such as hardwood-based materials. Furthermore, prior to assembling the filter 100, the filtration particles 116 are thoroughly rinsed and sorted so that no residue or particles may fall through the holes in the integral strainers 112 and 114 to potentially contaminate the fluid inside the fluid container 130.

Furthermore, the filter 100 needs only process a limited volume of fluid, e.g., the content of the bottle. In some embodiments, therefore, the choice of the filtration particles 116 also depends on the cost of the filtration particles 116 because the filter 100 is designed for only a single use-cycle. A single use-cycle as used herein refers to a cycle in which the filtration of a volume of fluid substantially equal to the capacity of the fluid container 130 may be completed. In other words, the filter 100 is not intended for re-use after the fluid container 130 has been emptied. As discussed above, the top and bottom of the housing 110 of the filter 100 are coupled to the integral strainers 112 and 114, respectively, using a sealant or an adhesive, thus making replacement of the filtration particles 116 difficult, if not impossible, without breaking the filter 100. Therefore, the filter 100 is limited to only a single use-cycle. Thus, the filter 100 may also be referred to as a disposable filter.

In some embodiments, the filter 100 further contains a flavoring substance to add flavor to the fluid as the fluid flows through the filter 100. For example, the flavoring substance may include some flavoring materials, spice, etc. The flavoring materials may dissolve into the fluid as the fluid flows through the filter 100. Alternatively, the flavoring materials may release some flavoring chemicals into the fluid as the fluid flows through the filter 100. Some examples of the flavor may include cherry, lime, coffee, etc. The flavor added into the fluid may further improve the taste of the fluid.

In some embodiments, the filter 100 further contains additional ingredients to improve the usefulness and/or quality of the fluid. Such additional ingredients may also be referred to as quality enhancing substance. For example, where the fluid is a beverage, the additional ingredients may include dietary supplements (e.g., herbal substance, vitamins, etc.), which may dissolve into the beverage to make the beverage more nutritious.

In some embodiments, the filter 100 further includes a flange 120 coupled to the integral strainer 112 on the top of the housing 110 via a liquid-proof seal. The flange 120 defines an opening 126 substantially at the center of the flange 120. An outer circumference 122 of the flange 120 is larger than the circumference of the top of the housing 110, while an inner circumference 124 of the flange 120 is smaller than the circumference of the top of the housing 110. The flange 120 may sit on a rim of the fluid container 130 when the filter 100 is inserted into the fluid container 130 to help prevent the filter 100 from dropping to the bottom of the fluid container 130. Moreover, a liquid-tight sealant may be applied to the bottom of the flange 120 to securely attach the flange 120 to the rim of the fluid container 130.

In some embodiments, the fluid container 130 is threaded as shown in FIG. 1A so that a cap 140 may be screwed onto the fluid container 130 to cap it. Alternatively, the fluid container 130 may be capped by a cork, a snap-on bottle cap, a cap with a dispenser (e.g., a spout), or another mechanism.

FIG. 1B illustrates a top view of the fluid container assembly 1000 without the cap 140. The cross-sectional view of the fluid container assembly 1000 shown in FIG. 1A is taken along line A in FIG. 1B. Referring to FIG. 1B, the flange 120 defines an opening 126 substantially at the center of the flange 120. Through the opening 126, the integral strainer 112 at the top of the filter 100 is exposed. As such, fluid inside the fluid container 130 may flow from the fluid container 130 into the filter 100 through the other integral strainer 114 at the bottom of the filter 100, and then may flow out of the filter 100 through the integral strainer 112 at the top of the filter 100. When the fluid flows through the filter 100, the fluid passes by the filtration particles 116, which remove impurities from the fluid. Thus, the fluid is filtered as the fluid is being dispensed from the fluid container 130.

In some embodiments, the fluid is an alcoholic beverage (e.g., vodka), which is typically filtered before being bottled into the fluid container 130. The filter 100 provides a second filtration to the alcoholic beverage as the fluid is dispensed from the fluid container 130. As such, the fluid dispensed from the fluid container 130 is freshly filtered just before use. Thus, the fluid dispensed may be referred to as being twice-filtered, double-filtered, bottle-filtered, and/or secondarily filtered. The above process to filter the fluid as it is being dispensed may further remove impurities from the fluid, thus improving the taste of the fluid. The impurities in the fluid inside the fluid container 130 may include impurities left over from previous filtration performed before bottling, as well as impurities formed in the fluid after bottling (e.g., during shipping and/or storage).

An additional advantage of filtering the fluid as the fluid is being dispensed is that users of the fluid container assembly 1000, such as consumers of the beverage contained therein, can view the filtration process as the beverage is dispensed from the fluid container 130. As such, the fluid container assembly 1000 provides a way for manufacturers of the beverage to demonstrate and to prove to the users that the beverage is being filtered at least twice (once before bottling and once as the fluid is being dispensed). Furthermore, as is well known in the beverage industry, packaging plays an important role in marketing. The fluid container assembly 1000 described herein allows consumers to see the filtration process for themselves, in addition to providing a unique appearance that helps set the beverage apart. Therefore, in addition to improving the taste of the beverage, the fluid container assembly 1000 also provides an edge in marketing.

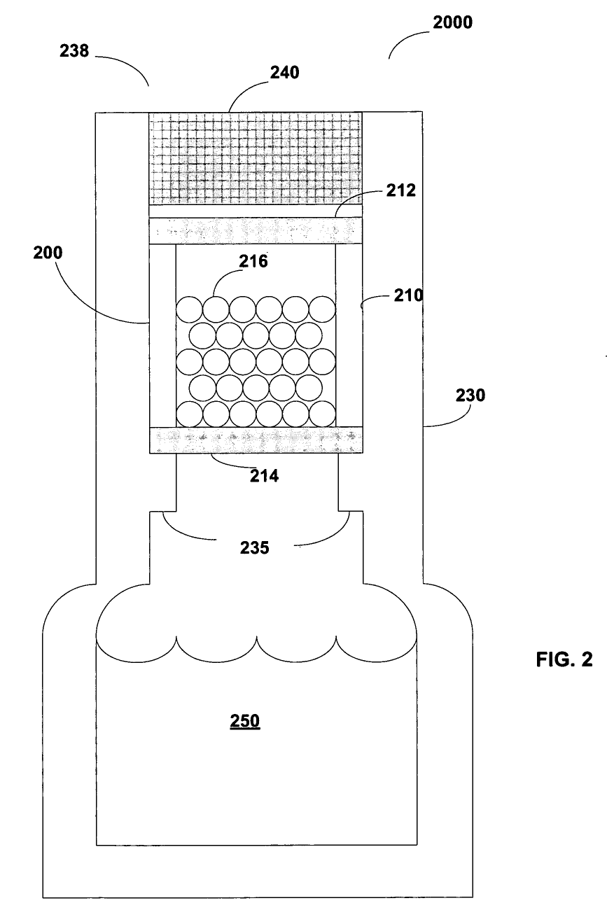

FIG. 2 illustrates a cross-sectional view of an alternate embodiment of a fluid container assembly. The fluid container assembly 2000 includes a fluid container 230, a filter 200, and a fluid container stopper 240 (e.g., a cork). To assemble the fluid container assembly 2000, the fluid container 230 is first filled with fluid 250, and then the filter 200 is inserted into the fluid container 230 above the fluid 250. The fluid container stopper 240 is inserted into the fluid container 230 after the filter 200 has been inserted such that the fluid container stopper 240 is placed above the filter 200.

The filter 200 includes a housing 210, a first integral strainer 212 coupled to the top of the housing 210, and a second integral strainer 214 coupled to the bottom of the housing 210. The housing 210 defines a cavity to store some filtration particles 216. In some embodiments, the housing 210 is made of a flexible material such that the housing 210 may be inserted into the neck of the fluid container 230 and provide a liquid-tight seal between an inner wall of the neck of the fluid container 230 and the housing 210. The integral strainers 212 and 214 may be made of a mesh having small holes defined on them to allow liquid to pass through while keeping the filtration particles within the housing 210. Note that the integral strainers 212 and 214 may or may not be made of the same material.

In some embodiments, an inner wall of the fluid container 230 defines a ridge 235 near a dispensing end 238 of the fluid container 230. The ridge 235 acts as a stopper to help prevent the filter 200 from dropping to the bottom of the fluid container 230 when inserted into the fluid container 230. Thus, the filter 200 may sit on the ridge 235 after being inserted into the fluid container 230.

When dispensing fluid 250 from the fluid container assembly 2000, the fluid container stopper 240 is removed from the assembly 2000 and the fluid container 230 is tilted to pour the fluid 250 out of the fluid container 230 through the dispensing end 238 of the fluid container 230. As the fluid 250 flows towards the dispensing end 238, the fluid flows into the filter 200 through the integral strainer 214. The fluid 250 is filtered by the filtration particles 216 as the fluid 250 flows pass the filtration particles 216 towards the other integral strainer 212. Finally, the fluid 250 flows through the integral strainer 212 and flows out of the fluid container 230 at the dispensing end 238. As such, the filter 200 filters the fluid 250 as the fluid is being dispensed from the fluid container 230.

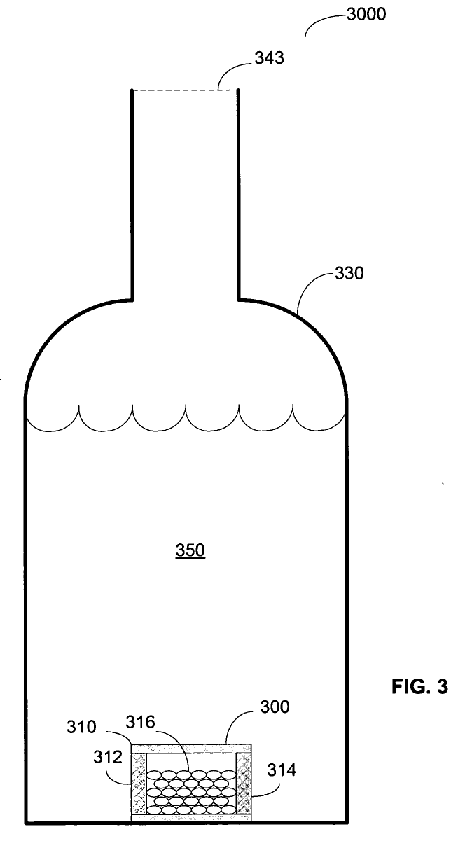

FIG. 3 illustrates an alternate embodiment of a fluid container assembly. The fluid container assembly 3000 includes a fluid container 330, a filter 300, and a mesh 343. To assemble the fluid container assembly 3000, the fluid container 330 is first filled with fluid 350, and then the filter 300 is dropped into the fluid container 330. Alternatively, the filter 300 may be dropped into the fluid container 330 prior to filling the fluid container with fluid 350. Note that the filter 300 is not attached to any part of the fluid container 330, in contrast to the embodiments discussed above. In other words, the filter 300 may be referred to as a “free-flowing” filter 300. After inserting the filter 300 and filling the fluid container 330, the mesh 343 may be mounted onto a dispensing end of the fluid container 330 to prevent the filter 300 from falling out of the fluid container 330 while allowing the fluid 350 to be dispensed out of the fluid container 330.

The filter 300 is designed for usage through a single-use cycle. In other words, the filter 300 is intended for filtering a predetermined volume of fluid limited to the volume of the fluid container 330. Thus, the filter 300 may also be referred to as a disposable filter. In some embodiments, the filter 300 includes a housing 310, a first integral strainer 312, a second integral strainer 314, and some filtration pellets 316. The housing 310 may be made of plastic safe to be in contact with food. The housing 310 has a first end and a second end. The first integral strainer 312 and the second integral strainer 314 are respectively coupled to the first end and the second end of the housing 310. The fluid 350 inside the fluid container 330 may flow pass through the filter 300 through the first integral strainer 312 and the second integral strainer 314. As the fluid 350 flows through the filter 300, the filtration particles 316 may filter the fluid 350. Furthermore, the filtration particles 316 may include activated carbon pellets, which are capable of absorbing or removing impurities to improve the taste of the fluid 350.

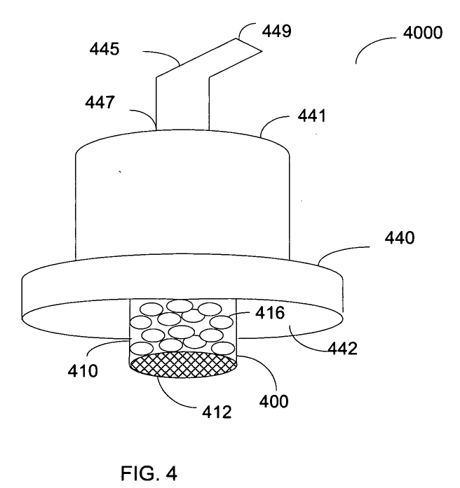

FIG. 4 illustrates an alternative embodiment of a fluid filter assembly. The fluid filter assembly 4000 includes a filter 400, a fluid container cap 440, and a spout 445. In some embodiments, the fluid filter assembly 4000 is used in conjunction with a fluid container (not shown) for holding alcoholic beverage (e.g., vodka, whiskey, etc.). For instance, one example of the fluid container is a vodka bottle. The fluid container cap 440 defines a single opening (not shown) and has a top 441 and a bottom 442. The top 441 is coupled to the spout 445 such that the opening opens into a first end 447 of the spout 445, where a second end 449 of the spout 445 is used to dispense fluid from the fluid container when the fluid filter assembly 4000 is attached to the fluid container. The filter 400 is coupled to the bottom 442 such that the filter 400 is inserted into the fluid container when the fluid filter assembly 4000 is attached to the fluid container. Furthermore, the filter 400 is substantially aligned with the opening of the fluid container cap 440 such that fluid flowing through the filter 400 may flow into the opening. The bottom 442 may be threaded to allow the fluid container cap 440 to be screwed onto a threaded dispensing end of the fluid container.

The filter 400 is designed for usage through a single-use cycle. In other words, the filter 400 is intended for filtering a predetermined volume of fluid limited to the volume of the fluid container. Thus, the filter 400 may also be referred to as a disposable filter. In some embodiments, the filter 400 includes a housing 410, a first integral strainer 412, a second integral strainer (not shown), and some filtration particles 416. The housing 410 defines a cavity to house the filtration particles 416, such as activated carbon pellets. The first integral strainer 412 and second integral strainer are coupled to the ends of the housing 410 to prevent the filtration particles 416 from falling out of the housing 410.

When the fluid filter assembly 4000 is attached to the fluid container, fluid inside the fluid container may be dispensed through the spout 445. As the fluid flows towards the spout 445, the fluid flows into the filter 400 through the first integral strainer 412. The filtration particles 416 inside the housing 410 of the filter 400 remove impurities from the fluid when the fluid passes by the filtration particles 416. Then the fluid flows out of the filter 400 through the second integral strainer and flows into the opening of the fluid container cap 440. Through the opening of the fluid container cap 440, the fluid flows into the spout 445 and flows out of the spout 445 through the second end 449 of the spout 445. As such, the fluid is filtered shortly before the fluid is dispensed from the fluid container via the fluid filter assembly 4000.

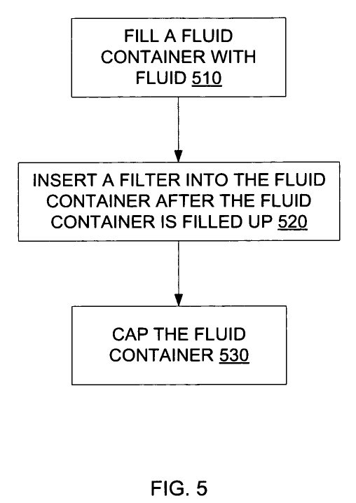

FIG. 5 illustrates one embodiment of a process to package or to bottle fluid. The process may be performed by bottling equipment including a combination of hardware and software. In some embodiments, the fluid is a beverage suitable for human consumption, such as alcoholic beverage (e.g., vodka, whiskey, etc.), water, etc. Referring to FIG. 5, the process begins with filling a fluid container (e.g., the fluid container 130 in FIG. 1A, the fluid container 230 in FIG. 2) with the fluid (processing block 510). After filling up the fluid container, a filter (e.g., the filter 100 in FIG. 1A, the filter 200 in FIG. 2, etc.) is inserted into the fluid container (processing block 520). In some embodiments, the filter may contain a flavoring substance (e.g., some flavoring materials) in addition to filtration particles. The flavoring substance may add flavor to the fluid when the fluid flows pass the filter during dispensing. Finally, the fluid container with the filter inserted is capped (processing block 530). For example, a cap, such as the cap 140 in FIG. 1A, is screwed onto an opening at a dispensing end of the fluid container. Alternatively, a stopper, such as a cork, may be inserted into opening of the fluid container to cap the fluid container. Alternatively, a snap-on cap with a built-in dispenser (e.g., a spout) may be snapped onto the fluid container.

Fluid packaged using the above process may have been filtered prior to being packaged in the fluid container. As the fluid is dispensed from the fluid container, the fluid flows pass the filter in the fluid container as described above to be filtered again by the filter. By filtering the fluid at least twice, where one of the filtration is performed prior to bottling and another one of the filtration is performed shortly before dispensing, more impurities in the fluid may be removed and thus, the taste of the fluid may be improved.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. An apparatus comprising:
a housing having a wall, a top, and a bottom, wherein the wall is made of a flexible material to provide a substantially liquid-tight seal between the wall and at least a portion of an inner wall of a fluid container when the housing is inserted into the fluid container;
a first integral strainer coupled to the top;
a second integral strainer coupled to the bottom; and
a plurality of filtration particles stored within the housing between the first and the second integral strainers.

2. The apparatus of claim 1, wherein the plurality of filtration particles include a plurality of activated carbon pellets.

3. The apparatus of claim 1, wherein the first integral strainer comprises a mesh defining a plurality of holes, each of the plurality of holes having a size smaller than a size of the plurality of filtration particles.

4. The apparatus of claim 1, further comprising:
a flange coupled to the top, the flange having an outer circumference larger than a circumference of the top of the housing, and an inner circumference smaller than the circumference of the top of the housing, such that the flange remains out of the fluid container when the housing is inserted into the fluid container.

5. The apparatus of claim 1, further comprising:
at least one of a quality enhancing substance and a flavoring substance stored within the housing between the first and the second integral strainers.

6. A fluid container assembly comprising:
a fluid container having a dispensing end, wherein a rim of the dispensing end defines a single opening of the fluid container; and
a disposable filter substantially inserted into the fluid container, the disposable filter comprising
a housing having a wall, a top, and a bottom, wherein the wall is made of a flexible material to provide a substantially liquid-tight seal between the wall and at least a portion of an inner wall of the fluid container when the housing is inserted into the fluid container,
a first integral strainer coupled to the top,
a second integral strainer coupled to the bottom, and
a plurality of filtration particles stored within the housing between the first and the second integral strainers.

7. The fluid container assembly of claim 6, wherein the disposable filter further comprises:
a flange coupled to the top of the filter, the flange having an outer circumference larger than a circumference of the top of the housing, and an inner circumference smaller than a circumference of the top of the housing, wherein the flange sits on a rim of the dispensing end of the fluid container when the filter is inserted into the fluid container.

8. The fluid container assembly of claim 6, wherein the plurality of filtration particles comprise a plurality of activated carbon pellets.

9. The fluid container assembly of claim 6, wherein an inner wall of the fluid container defines a ridge near the dispensing end of the fluid container such that the ridge holds the disposable filter in place when the disposable filter is inserted into the fluid container.

10. The fluid container assembly of claim 9, further comprising a stopper, wherein at least a portion of the stopper is inserted into the fluid container to seal the opening of the dispensing end of the fluid container.

11. The fluid container assembly of claim 6, further comprising a cap overlaying the opening at the dispensing end to cover the first integral strainer of the disposable filter.

12. The fluid container assembly of claim 11, wherein the fluid container further comprises a first plurality of threads disposed on a portion of an outer wall of the fluid container near the dispensing end, and the cap comprises a second plurality of threads disposed on an inner wall of the cap to mate with the first plurality of threads.

13. The fluid container assembly of claim 6, wherein the disposable filter further comprises:
at least one of a quality enhancing substance and a flavoring substance stored within the housing between the first and the second integral strainers.

14. An improved alcoholic beverage bottle comprising:
a bottle defining an opening where an alcoholic beverage is dispensed; and
a filter disposed within the bottle to filter the alcoholic beverage when the alcoholic beverage is dispensed, wherein the filter is a disposable filter designed for a single-use cycle.

15. The improved alcoholic beverage bottle of claim 14, wherein the filter further comprises:
a housing defining a cavity, the housing having a first end and a second end;
a plurality of activated carbon pellets held in the cavity of the housing;
a first integral strainer coupled to the first end of the housing; and
a second integral strainer coupled to the second end of the housing.

16. The improved alcoholic beverage bottle of claim 15, wherein the filter further comprises:
at least one of a quality enhancing substance and a flavoring substance held in the cavity of the housing.

17. The improved alcoholic beverage bottle of claim 14, further comprising:
a cap covering the opening of the bottle, wherein the filter is directly attached to the cap.

18. The improved alcoholic beverage bottle of claim 14, further comprising:
a mesh covering the opening of the bottle, wherein the filter is free-flowing within the bottle and the mesh prevents the filter from falling out of the bottle.

19. A method to bottle fluid in a fluid container assembly, the method comprising:
filling the fluid container with the fluid, the fluid container having a dispensing end to define an opening; and
inserting a disposable filter into the fluid container through the opening after the fluid container has been substantially filled up, the disposable filter including a housing made of a flexible material to provide a substantially liquid-tight seal between the housing and at least a portion of an inner wall of the fluid container when the disposable filter is inserted into the fluid container, wherein the housing stores a plurality of filtration particles to filter the fluid when the fluid is being dispensed from the fluid container.

20. The method of claim 19, wherein the fluid is an alcoholic beverage.

21. The method of claim 19, further comprising:
capping the fluid container.

22. The method of claim 19, further comprising:
inserting a stopper into the fluid container through the opening.
